(19) United States
(12) Patent Application Publication
(10) Pub. No.: US 2012/0137569 A1
(43) Pub. Date: Jun. 7, 2012

(54) Apparatus and Method for Detecting, Eradicating and Disposing of Bugs and Pests

(76) Inventor: George Younts, Clifton, MI (US)

(21) Appl. No.: 13/308,839

(22) Filed: Dec. 1, 2011

Related U.S. Application Data
(60) Provisional application No. 61/418,554, filed on Dec. 1, 2010.

(51) Int. Cl. A01M 3/00

(52) U.S. Cl. 43/139

(57) ABSTRACT

An apparatus and method for eradicating and disposing of bugs and pests. An inlet hose is connected to an inlet opening of a housing having a cutting or shredding device movably mounted therein. The hose or inlet opening may have a cutting screen removably mounted therein for initially shredding bugs and pests entering the hose. A first motor is connected to the housing for moving the cutting or shredding device therein. A second motor is connected to the housing for creating a vacuum within the housing and the inlet hose to suck bugs and pests into the inlet hose and into the housing. A waste container is removably mounted on the housing. When the first and second motors are operated, the inlet hose can be positioned to suck bugs and pests into the housing for shredding.

### CROSS-REFERENCES TO RELATED APPLICATIONS

This application claims the priority of Provisional Patent Application No. 61/418,554 filed on Dec. 1, 2010.

### BACKGROUND OF THE INVENTION

1. Field of the Invention

The present invention relates to an apparatus and method for detecting, eradicating and disposing of bugs and pests.

2. Description of the Background Art

There exists a major need for apparatus and methods to detect, eradicate and dispose of bugs and pests. Current methods are primarily dependent on the use of chemical products in various forms and applications. They are available in solid, powder or liquid (sprayed) form. There are also limited and most often costly ways of sealing and modifying temperature in controlled and sealed spaces to eradicate bugs and pets. This technique often has to be supplemented by use of chemicals.

There are also secondary effects that can be a problem primarily to guard against persons (adults and children) not inhaling or having contact with the chemicals. Generally, the more effective the use of chemical products the more danger that may result from failure to follow arduously the safety and procedural rules and regulations. The method and apparatus of the present invention is unique in that it uses no chemicals and does not feature complicated preparation of the area being treated. It also removes all residual products as a result of the destruction of the bugs and pests. The minute bits and pieces are easily contained and in fact may have a useful purpose such as use as a fertilizer or the like. There are no adverse secondary effects.

The present method and apparatus has many advantages as follows:
1. User friendly;
2. Fast and effective with high efficiency;
3. Requires minimal training;
4. Does not require the use of any chemicals;
5. Leaves no residue;
6. Minimum expense in application;
7. Adaptable to different size systems (hand held up to van configuration) and demand applications;
8. Modular in design making it easy to repair;
9. Environmentally friendly;
10. Can be effectively used against a very large variety of bugs and pests;
11. Requires no special treatment or change in the area to be treated;
12. Area being treated can be returned to normal use immediately without any special actions; and
13. Direct AC or battery powered with self contained charger.

### BRIEF SUMMARY OF THE INVENTION

The apparatus of the present invention comprises a housing and an inlet hose removably connected to an inlet opening of the housing. The hose or inlet opening may have a cutting screen removably mounted therein for initially shredding bugs and pests entering the hose. One or more cutting or shredding devices are movably mounted within the housing. A first motor is connected to the cutting or shredding devices for moving them and a second motor is connected to the housing for creating a vacuum within the housing and the inlet hose to suck bugs and pests into the inlet hose and into the housing with the cutting or shredding devices therein. A waste container is removably connected to the housing.

When the first and second motors are operated, the inlet hose can be positioned to suck bugs and pests therein that can be initially shredded by the cutting screen in the inlet hose or inlet opening and flow into the housing where they are further cut and shredded into small particles by the cutting or shredding devices and are collected in the waste container for removal from the apparatus. The cutting and shredding device or devices in the housing may be of any suitable construction as more fully described hereinafter.

### BRIEF DESCRIPTION OF THE DRAWINGS

FIG. 1 is a side elevational view of one embodiment of the apparatus of the present invention with parts shown schematically;

FIG. 2 is a front elevational view of one embodiment of a cutting screen removably mounted within the inlet hose of the apparatus;

FIG. 3 is a side elevational view, with parts broken away, of a second embodiment of the cutting and shredding device movably mounted within the housing of the apparatus shown in FIG. 1;

FIG. 4 is a side elevational view, with parts broken away, of a third embodiment of the cutting and shredding device movably mounted within the housing of the apparatus shown in FIG. 1;

FIG. 5 is a sectional view taken along line 5-5 in FIG. 3; and

FIG. 6 is a sectional view taken along line 6-6 in FIG. 4.

### DETAILED DESCRIPTION OF THE INVENTION

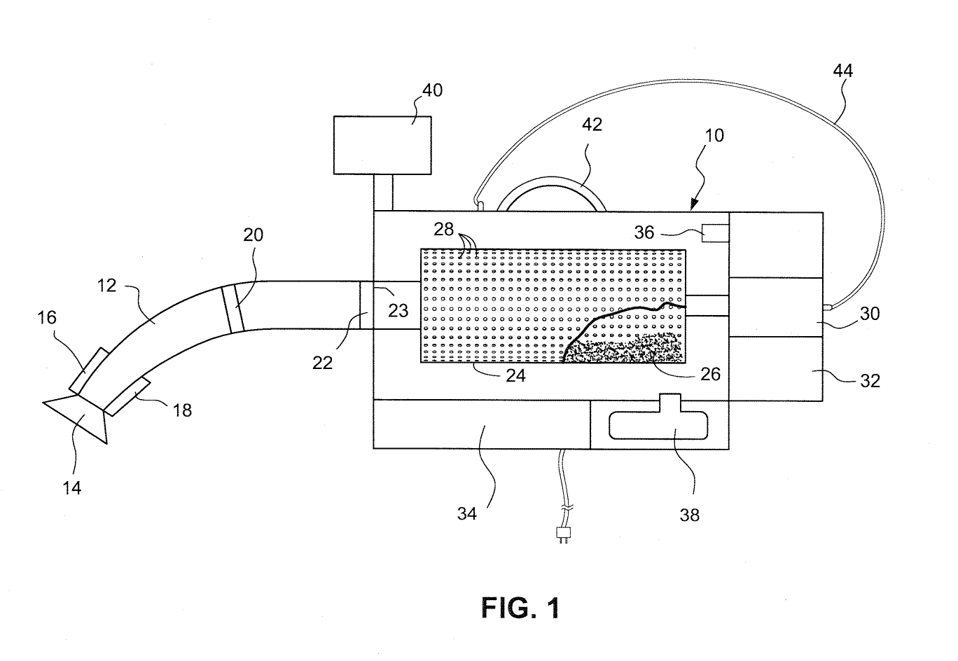

As shown in FIG. 1, the bug and pest eradicating apparatus of the present invention comprises a housing 10 of any suitable size and configuration, and formed of any suitable material such as metal or plastic. An inlet hose 12 which is preferably of flexible construction is removably connected to one end of the housing and comprises at its outer end an inlet nozzle 14 of any suitable construction. A video camera and light source 16 may be removably connected to the nozzle 14 or the adjacent outer end of the inlet hose 12. Also, an IR detector 18 may be removably mounted on the nozzle 14 or on the adjacent outer end of the inlet hose 12.

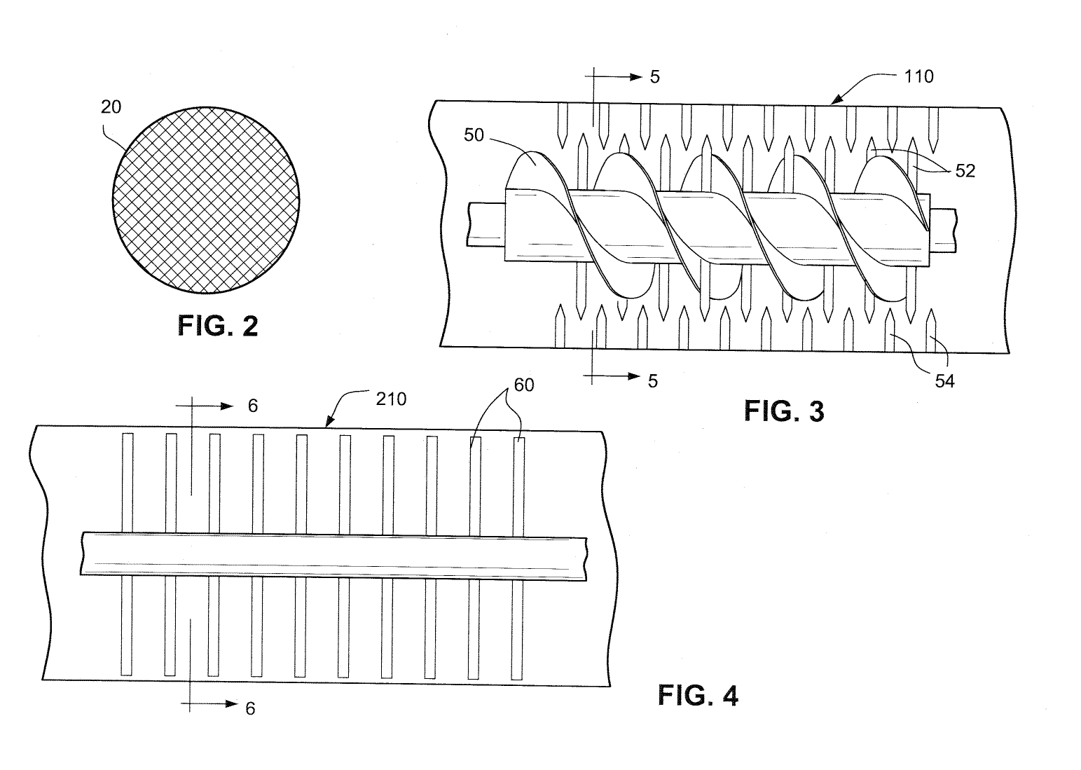

A cutting screen 20 may be removably mounted within the inlet hose 12 and may be of any suitable construction such as a very fine sharp wire grid as shown in FIG. 2.

The inner end of the hose 12 may be removably connected to the inlet opening 23 of the housing 10 in any suitable manner such as by a slip ring connection 22 which preferably is airtight. As an alternate embodiment, the cutting screen may be removably mounted within the inlet opening 23 of the housing 10.

In the embodiment shown in FIG. 1, a perforated inner chamber or drum 24 is rotatably mounted within the housing 10 and has a suitable granular abrasive material 26 such as sand therein of a size larger than the perforations 28 in the drum so as to be retained therein when the drum is rotated. A drive motor 30 is mounted on the housing 10 for rotating the drum 24.

A vacuum motor 32 is connected to the housing 10 for creating a vacuum within the housing 10, the drum 24 and the inlet hose 12 when the vacuum motor is operated.

A power module 34 is connected to the housing 10 for providing power to various components of the apparatus, such as the drive motor 30 and vacuum motor 32. The power module 34 is constructed to be connected to 120/220 volts AC and/or a rechargeable battery of any suitable construction.

A source of ultraviolet radiation 36 may be located within the housing 10 to kill any bug eggs that may pass through the perforated drum 24 or to neutralize any organic residue.

A waste chamber or container 38 is removably connected to the housing 10.

A control/display panel 40 may be mounted on the upper portion of the housing 10 and is operatively connected to the power module 34, the video camera and light source 16, the infrared sensor 18 and other components of the apparatus.

For easy handling, in a hand-held embodiment, the housing 10 may be provided with a handle 42 and/or a shoulder strap 44.

In the operation of the apparatus shown in FIG. 1, the power module 34 is activated to turn on the video camera and light source 16 and the IR sensor 18 and also to operate the drive motor 30 to rotate the perforated drum 24 and to operate the vacuum motor 32 to create a vacuum in the inlet hose 12, perforated drum 24 and housing 10. The video camera and light source 16 and the IR sensor 18 facilitate the locating of bugs or pests to be eradicated.

The inlet hose 12 and nozzle 14 can then be manipulated by an operator to suck bugs and other pests that have been located into the inlet hose 12, through the cutting screen 20 and then into the rotating perforated drum 24 where the bugs and pests cut and shredded by the cutting screen 20 are ground to a smaller size by the granular abrasive material 26 in the rotating drum 24. The ground bugs and pests then pass through the perforations 28 in the rotating drum 24 into the housing 10 by the force of the vacuum created by the vacuum pump 32 and fall into the removable waste container 38 which can then be removed to dispose of the ground materials. Since the granular abrasive material 26 in the drum 24 is of a size larger than the perforations 28 therein, the abrasive material is retained in the drum for further use.

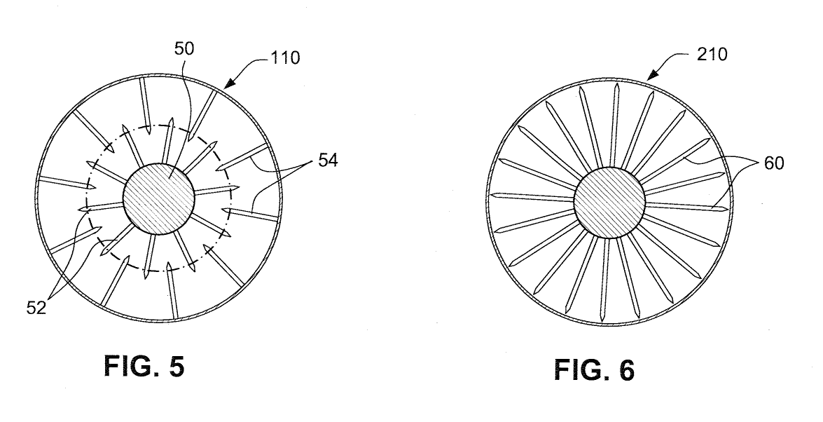

FIGS. 3 and 5 illustrate a second embodiment of a device located within the housing 110 for cutting and shredding bugs and other pests sucked into the housing 110 to a predetermined or suitable size to be received within the removable waste container 38. Other than the cutting and shredding device, the construction and operation of the second embodiment is the same as the apparatus of FIG. 1.

In the embodiment of FIG. 3, the cutting and shredding device is a rotating feed screw 50 having outwardly extending cutting blades 52 in spaced relation thereon that are disposed between cutting blades 54 mounted on and extending inwardly from the housing 110 in spaced relation thereon. The rotation of the feed screw 50 and vacuum created in the housing 110 serves to advance bugs and pests along the feed screw and through the cutting blades 52 and 54 so that the bugs and pests are shredded to a small size and deposited in the waste container 38 shown in FIG. 1.

A third embodiment of a cutting and shredding device rotatably mounted within the housing 210 is shown in FIGS. 4 and 6 wherein one or more circular cutting devices 60 are rotatable within the housing 210 for cutting and shredding incoming bugs and pests into a smaller or predetermined size as they are pulled through the housing by the vacuum pump 32 and are received in the removable waste container 38 of FIG. 1. The shredding and cutting devices 60 may be of any suitable construction, such as that shown in FIG. 6, for cutting and shredding the incoming bugs and pests to a desired small size for disposal, and extend outwardly to the adjacent inner surface of the housing 210.

The operation of the apparatus with the third embodiment of the cutting and shredding device is the same as that described for the apparatus shown in FIG. 1.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. Apparatus for eradicating and disposing of bugs and pests, the apparatus comprising:
a housing having an inlet opening;
an inlet hose removably connected to the inlet opening of the housing;
a cutting or shredding device movably mounted within the housing;
a first motor connected to the housing for moving the cutting or shredding device;
a second motor connected to the housing for creating a vacuum within the housing and the inlet hose to suck bugs and pests into the inlet hose, into the housing and through the cutting or shredding device within the housing; and
a waste container removably connected to the housing;
whereby when the first and second motors are operated, the inlet hose can be positioned to suck bugs and pests therein that flow into the housing where they are shredded into small particles by the cutting or shredding device and flow through the housing into the waste container for removal from the apparatus.

2. The apparatus of claim 1 wherein a cutting screen is removably mounted within the hose or the inlet opening of the housing for initially shredding bugs and pests entering the hose.

3. The apparatus of claim 1 wherein the cutting or shredding device is a perforated drum containing a granular abrasive material therein that is larger than perforations in the drum;
the drum being rotatable within the housing so that bugs and pests received therein are ground into small particles by the granular abrasive material and flow through the perforations in the drum into the housing and then into the waste container for removal from the apparatus.

4. The apparatus of claim 1 wherein the cutting or shredding device is a feed screw rotatably mounted within the housing and having outwardly extending cutting blades spaced along a length thereof, the housing having inwardly extending cutting blades extending along a length thereof and disposed between the outwardly extending cutting blades on the feed screw;
whereby when the first and second motors are operated, the bugs and pests entering the housing are advanced by the vacuum and by the rotation of the feed screw and are cut into small particles by the inwardly and outwardly extending cutting blades and flow into the waste container for removal from the apparatus.

5. The apparatus of claim 1 wherein the cutting or shredding device comprises one or more circular cutting devices rotatably mounted within the housing and spaced along a length thereof, the cutting devices extending outwardly to the adjacent inner surface of the housing so that bugs and pests entering the housing are shredded by the circular cutting devices rotating therein to grind them into small particles that enter the waste container for removal from the apparatus.

6. The apparatus of claim 1 wherein the inlet hose is flexible and comprises an inlet nozzle on an outer end thereof.

7. The apparatus of claim 6 wherein a closed circuit TV, light source and infrared detector are mounted on the inlet nozzle and/or the outer end of the inlet hose.

8. The apparatus of claim 7 wherein a control and display panel is mounted on the housing and is connected to the closed circuit TV, light source and infrared detector.

9. The apparatus of claim 2 wherein the cutting screen is a sharp wire grid.

10. The apparatus of claim 3 wherein the first motor is operable to effect intermittent rotation of the perforated drum.

11. The apparatus of claim 3 wherein the granular abrasive material is sand having a granular size that is larger than the perforations in the drum.

12. The apparatus of claim 1 further comprising a power module connected to the housing for operating the first motor and the second motor.

13. The apparatus of claim 1 being of portable or hand-held size, and wherein the housing comprises a handle and/or shoulder strap.

14. The apparatus of claim 1 being of modular construction and wherein the inlet hose, first motor, second motor and waste container are removably connected to the housing.

15. A method for eradicating and disposing of bugs and pests, the method comprising:
drawing by vacuum bugs and pests through an inlet hose into an inlet opening in a housing having a cutting or shredding device movably mounted in the housing;
advancing the bugs and pests by vacuum through the housing and moving the cutting or shredding device to grind the bugs and pests into small particles; and
removing the ground bugs and pests from the housing.

16. The method of claim 15 wherein the inlet hose or the inlet opening has a cutting screen removably mounted therein to initially shred the bugs and pests to a smaller size before they are drawn into the housing.

17. The method of claim 15 wherein the cutting or shredding device is a perforated drum rotatably mounted within the housing and wherein the bugs and pests are drawn by vacuum into the perforated drum where they are ground into small particles by a granular abrasive material in the drum as it is rotated.

18. The method of claim 15 wherein the cutting or shredding device comprises a feed screw rotatably mounted within the housing and comprising outwardly extending cutting blades in spaced relation thereon, and wherein the housing has inwardly extending cutting blades in spaced relation thereon that are disposed between the outwardly extending cutting blades of the feed screw.

19. The method of claim 15 wherein the cutting or shredding device comprises one or more circular cutting devices rotatably mounted within the housing and extending outwardly to an adjacent inner surface of the housing.

20. The method of claim 19 wherein the circular cutting devices are in spaced relation along a length of the housing.
